(19) United States
(12) Patent Application Publication
(10) Pub. No.: US 2023/0210723 A1
(43) Pub. Date: Jul. 6, 2023

(54) Prefilled Medicated Pacifier

(71) Applicant: Steve Huck, Baldwin, MI (US)

(72) Inventor: Steve Huck, Baldwin, MI (US)

(21) Appl. No.: 18/150,296

(22) Filed: Jan. 5, 2023

Related U.S. Application Data
(60) Provisional application No. 63/296,588, filed on Jan. 5, 2022.

(51) Int. Cl. A61J 7/00; A61J 17/00

(52) U.S. Cl. CPC A61J 7/0053; A61J 17/001; A61J 2200/76

(57) ABSTRACT

The present invention relates to an improved pacifier to provide a pre-measured medication or supplement to an infant without requiring teaspoons, medical cups, and more. The improved pacifier features a substantially transparent nipple which is prefilled, or selectively filled, with a liquid medication or supplement that allows an infant to suck the nipple to dispense the medication or supplement in their mouth. The nipple is releasably attached to a shield device through a central opening of the shield. The shield also inhibits the pacifier from falling out of the mouth and dropping on the ground. The nipples are color coded in different colors for indicating different medications. Pre-measured dosage marks are indicated on the nipple for indicating the quantity of the medication stored in the nipple.

### CROSS-REFERENCE TO RELATED APPLICATION

The present application claims priority to, and the benefit of, U.S. Provisional Application No. 63/296,588, which was filed on Jan. 5, 2022, and is incorporated herein by reference in its entirety.

### FIELD OF THE INVENTION

The present invention relates generally to the field of infant pacifiers and medication dispensers. More specifically, the present invention relates to a novel prefilled medicated pacifier for parents and guardians to easily administer medicine, vitamins, or other medical products to children. The pacifier includes a nipple prefilled with a medication or supplement that is releasably attached to a shield. A child can suck on the pacifier to receive or slowly ingest medication rather than being fed liquid medications on a spoon or in a medicine cup. Accordingly, the present disclosure makes specific reference thereto. Nonetheless, it is to be appreciated that aspects of the present invention are also equally applicable to other like applications, devices, and methods of manufacture.

### BACKGROUND

By way of background, infants and toddlers require non-prescription medication, prescription medication, vitamins, food supplements, juices, and more at home for adequate nutrition, prevention from illnesses, and proper growth. Commonly, an adult, such as a parent or a caretaker, administers the medications and supplements using a dropper, small cup, spoon, or any other similar device. This way of administering medication is ineffective, wasteful, inaccurate, time consuming, and requires the adult to physically be present near the infant. Often, the quantity of medication is inaccurate as the quantity is manually measured by a user using a teaspoon or small cup. Further, the child may resist, or refuse taking the medication or may spit out the medication, resulting in waste. The refusal to take medication can lead to prolonged periods of illness or complications with ensuring adequate dosages.

A common problem in administering medication in a conventional manner faced by individuals is the dripping of medication on clothes of the infants and adult. This also leads to inaccurate quantity of medication given to the infant. Many times, fingers of the infant or adult touches the medication or supplement, which may lead to contamination. Such contamination by foreign substances can be potentially dangerous for the infant.

Many adults are not qualified or aware about the type and quantity of medication to be provided to an infant. Elderly individuals face difficulties in manually administering medication and supplements to infants. It is thus apparent that individuals desire an improved device and associated method for providing pre-measured doses of medication, vitamins, and food supplements to infants.

Infants like to use pacifiers for long periods of time. In fact, many infants and toddlers are happiest when they are sucking on something. Infants sleep easy and light when using pacifiers. However, pacifiers for administering accurate amount of medication and supplements are not available in the market.

Therefore, there exists a long-felt need in the art for a device that allows an adult to give infants liquid medication, vitamins, and food supplements easily. There is also a long-felt need in the art for a medication administering device that eliminates the use of tablespoons, small cups, and more for administering medicine to infants. Additionally, there is a long-felt need in the art for a prefilled medicated pacifier to easily administer to children medicine, vitamins, or other medical products. Moreover, there is a long-felt need in the art for a medication dispenser that is prefilled with a desired quantity of medication or supplement. Further, there is a long-felt need in the art for a medication administering pacifier device that can be used for administering different types of medications easily and quickly. Furthermore, there is a long-felt need in the art for a medication administering device that eliminates contamination of medication and supplements. Finally, there is a long-felt need in the art for a simple prefilled medication dispenser for children that is used for delivering various medications to an infant like cold medicine, vitamins, and more.

The subject matter disclosed and claimed herein, in one embodiment thereof, comprises a medication dispensing pacifier for infants. A child can suck on the pacifier to receive medication rather than being fed liquid medications on a spoon or in a medicine cup. The pacifier further comprises a rigid plastic shield having a central opening therein, a pacifier ring attached to a first surface of the shield, a food grade silicone nipple, the nipple having a plurality of pre-measured doses (i.e., volume indicators) printed thereon for indicating quantity of medication filled inside the nipple, the nipple having a rubber base and an opposite suckling end and a notch, wherein the nipple is notched in the central opening of the shield using the notch, enabling the shield to accept the nipple such that the suckling end and the pointed end of the nipple are on opposite sides of the shield. A pre-structured orifice located at the suckling end of the nipple is used for dispensing the stored medication into the mouth of an infant when the nipple is sucked by the infant.

In this manner, the prefilled medication pacifier device or supplement dispensing pacifier device of the present invention accomplishes all of the foregoing objectives and provides users with a prefilled medicated pacifier for parents and guardians to easily administer medicine, vitamins, or other medical products to children. The nipple of the device is sucked easily by infants to consume medication rather than being fed liquid medication through a cup or spoon. The device eliminates contamination of the medication and helps in providing an accurate quantity of the medication or supplement.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a medication dispensing pacifier for infants. The pacifier is designed for parents and guardians to easily administer medicine, vitamins, or other medical products to children without use of a small cup, tablespoon, and the like. The pacifier further comprises a circular rigid plastic shield having a central opening therein, a pacifier ring attached to a first surface of the shield, an elongated food grade and substantially transparent silicone nipple, the nipple having a plurality of pre-measured doses (i.e., volume indicators) printed thereon, the nipple having a pointed end and an opposite suckling end and a notch at about 10 mm from the pointed end, wherein the nipple is notched in the central opening of the shield using the notch enabling the shield and the ring to accept the nipple such that the suckling end and the pointed end of the nipple are on opposite sides of the shield. A liquid medication, vitamin, food supplement, and the like are stored in the nipple, such that the medication, vitamin, or food supplement is passed through a pre-structured orifice located at the suckling end of the nipple for dispensing same into the mouth of an infant.

In a further embodiment of the present invention, a prefilled medicated pacifier is disclosed. The pacifier includes a nipple prefilled with a medication and having pre-measured doses or volume indicators printed thereon, an orifice on a suckling end of the nipple for dispensing the prefilled medication when the nipple is sucked by an infant. The nipple is releasably attached to a shield such that the pacifier is sucked by the infant like a conventional pacifier, but the infant receives medication without the need of any teaspoon, medical cup, or the like. The nipple comes in different colors wherein each color can be used to indicate a different medication inside the nipple.

In a further embodiment of the present invention, the shield is sized to avoid the possibility of a child swallowing or choking on the pacifier. The mouth shield covers the lips, and some part of the chin proximal to the lips, to provide adequate support to retain the pacifier in the mouth of an infant or child.

In a further embodiment of the present invention, a method for administering medication or supplements to an infant is described. The method includes the steps of filling a nipple with a medication, attaching the nipple to a pacifier shield device, sucking the nipple by an infant, dispensing the medication from an orifice of the nipple, ingesting the medication by an infant, and removing the nipple from the pacifier after use.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a prefilled medication pacifier of the present invention in accordance with the disclosed architecture;

FIG. 2 illustrates a perspective view of the pacifier device of FIG. 1 in an unassembled form with the nipple detached from the shield in accordance with the disclosed architecture;

FIG. 3 illustrates a perspective view of another embodiment of the prefilled medicated pacifier device of the present invention in accordance with the disclosed architecture;

FIG. 4 illustrates a perspective view of another embodiment of disposable nipple used with the pacifier device of the present invention in accordance with the disclosed architecture;

FIG. 5A illustrates one potential packaging arrangement for sanitized nipples used with the medication dispensing pacifier device of the present invention in accordance with the disclosed architecture;

FIG. 5B illustrates another potential packaging arrangement for sanitized nipples used with the medication dispensing pacifier device of the present invention in accordance with the disclosed architecture; and

FIG. 6 illustrates a flow diagram depicting steps in use of the prefilled medicated pacifier of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a device that allows an adult to administer liquid medication, vitamins, and/or food supplements easily to an infant. There is also a long-felt need in the art for a medication administering device that eliminates use of tablespoons, teaspoons, small cups, and more for administering medicine to infants. Additionally, there is a long-felt need in the art for a prefilled medicated pacifier to easily administer medicine, vitamins, or other medical products to children. Moreover, there is a long-felt need in the art for a medication dispenser that is prefilled with a desired quantity of medication or supplement. Further, there is a long-felt need in the art for a medication administering pacifier device that can be used for administering different types of medications easily and quickly. Furthermore, there is a long-felt need in the art for a medication administering device that eliminates contamination of medication and supplements. Finally, there is a long-felt need in the art for a simple prefilled medication dispenser for children that is used to deliver various medications to an infant like cold medicine, vitamins, and more.

The present invention, in one exemplary embodiment, is a method for feeding or administering medication or supplements to an infant. The method includes the steps of filling a nipple with a medication wherein a color of the nipple can indicate the particular medication, attaching the nipple to a pacifier shield device by passing a base of the nipple through an opening of the shield, sucking the nipple by an infant, dispensing the medication from an orifice of the nipple, and removing the nipple from the pacifier after use. A new nipple can be attached to the shield for dispensing another medication to the infant.

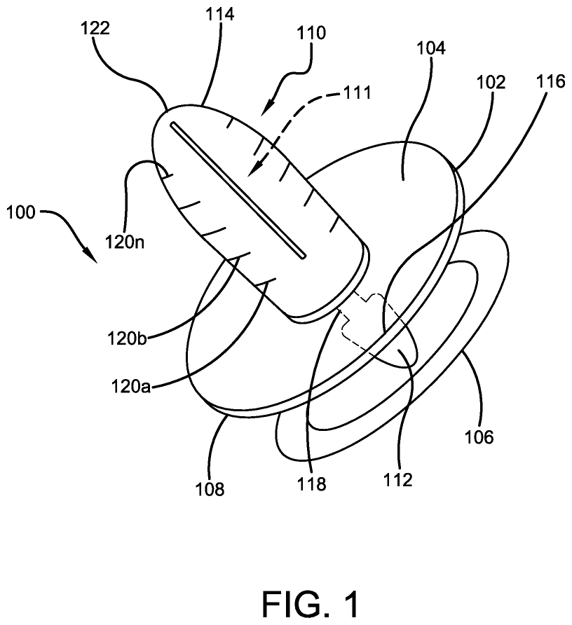

Referring initially to the drawings, FIG. 1 illustrates a perspective view of one potential embodiment of a prefilled medication pacifier of the present invention in accordance with the disclosed architecture. The prefilled medication pacifier device 100 of the present invention is designed to store and dispense pre-measured doses of medication, vitamins, or supplements contained in sanitized disposable unitary nipples. The pacifier 100 includes a mouth shield 102 having a substantially planar body. Further, the shield 102 includes an interior surface 104 oriented towards the mouth of an infant when the pacifier device 100 is in use for dispensing medication into the mouth of the infant. A ring 106 is attached to the exterior surface 108 of the shield 102, wherein the ring 106 is used for holding the pacifier device 100.

A disposable unitary nipple 110 having a base or pointed end 112 and an opposite suckling end 114 is configured to releasably insert through a central opening 116 of the shield 102. A notch 118 of the nipple 110 abuts against the shield 102, such that the suckling end 114 and the pointed end 112 are oriented on opposite sides of the shield 102. The nipple 110 is made of food grade and sanitized rubber or silicone such that while inserting the nipple 110 through the opening 116, the pointed end 112 easily passes through the opening 116 to abut the notch 118. The suckling end 114 orients toward the interior surface 104 of the shield 102 and the pointed end 112 orients toward the exterior surface 108 of the shield 102. The nipple 110 includes a cavity portion 111 (i.e., hollow portion) that can be prefilled with a specific type of medicine, vitamin, or supplement. The nipple 110 is substantially transparent. Further, in exemplary embodiments, nipples 110 prefilled with different types of medications, vitamins, and/or supplements can be formed in different colors enabling a user to uniquely identify the medications, vitamins, and/or supplements.

The nipple 110 has a plurality of pre-measured dosage indicators or markings 120a-n marked thereon enabling a user, such as a parent or guardian, to administer a desired and accurate quantity of the medication stored in the nipple 110. The suckling end 114 has a pre-structured orifice 122 for dispensing the stored medication uniformly when the nipple 110 is sucked by an infant. This eliminates the requirement of use of teaspoons, small cups, and the like, for giving medications and supplements to infants and toddlers.

The prefilled medicated pacifier 100 of the present invention may be made from materials free from PVC, BPA, artificial coloring, chemical softeners, phthalates, and nitrosamines. The pacifier 100 can come in different sizes that are appropriate for infants and toddlers up to several years old. The nipple 110 can be disposable and can be thrown away after one use by removing it from the shield 102 thereby preventing any cross contamination. The shield 102 may come in a variety of colors and the exterior surface 108 may further comprise different indicia such as designs, patterns, a company logo, personalized name, customized design, or the like as per the requirements of the user.

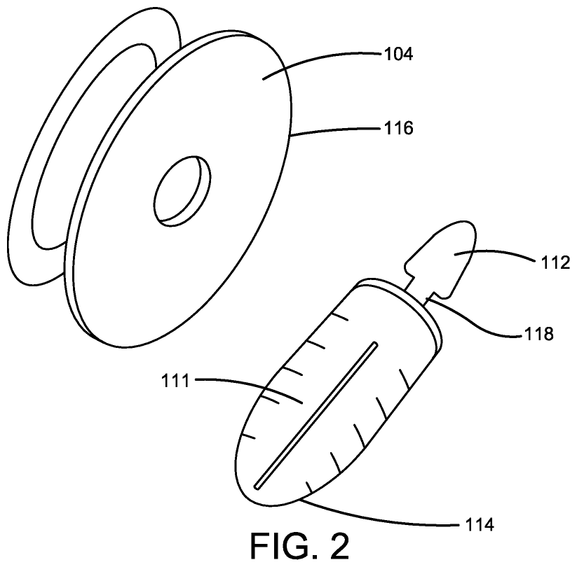

FIG. 2 illustrates a perspective view of the pacifier device 100 of FIG. 1 in an unassembled form with the nipple detached from the shield in accordance with the disclosed architecture. As illustrated, the hole or opening 116 is formed at the center of the shield 102 and is dimensioned to receive the base 112 of the nipple 110 therethrough and the notch 118 interlocking with the shield 102. Although, in the present embodiment, the shield 102 is circular in shape, it is to be appreciated that the shield can have any shape to resemble a conventional infant pacifier. The nipple 110 is unitary and different nipples can be repeatedly inserted into a durable and reusable pacifier shield 102.

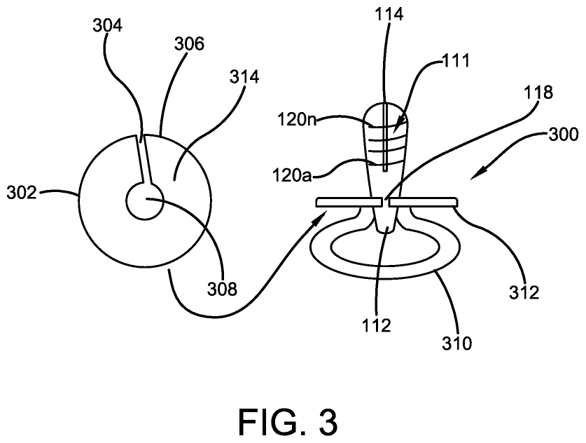

FIG. 3 illustrates a perspective view of another embodiment of the prefilled medicated pacifier device of the present invention in accordance with the disclosed architecture. In the present embodiment, the shield 302 of the pacifier device 300 has a continuous slit 304 extending from the periphery 306 to the central opening 308 of the shield 302. A ring 310 is attached to the exterior surface 312 of the shield 302 for holding the pacifier device 300 during use.

For releasably inserting the nipple 110, the base 112 is passed through the shield 102 from the interior surface 314 toward the exterior surface 312 through the hole 308 such that the notch 118 is interlocked with the shield 302. The slit 304 is used for removing, as well as inserting, the nipple 110 as the notch 118 can be dragged along the slit 304 for removing the nipple 110. All other specifications of the nipple 110 and use of the device 300 remains similar to the device 100 of other embodiments of the present invention.

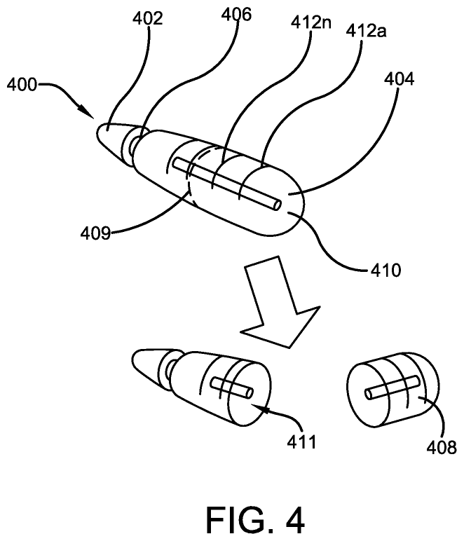

FIG. 4 illustrates a perspective view of another embodiment of a disposable nipple used with the pacifier device of the present invention in accordance with the disclosed architecture. In the present embodiment, the nipple 400 may not be prefilled with a medication but can be filled by a user for administering to an infant. The nipple 400 has a base 402 and a suckling end 404 along with a notch 406 similar to a structure of the nipple 110 described above in the disclosure. The nipple 400 has a detachable portion 408 that can be removed for filling or placing a medication or supplement inside a cavity 411 of the nipple 400. The removable portion 408 is designed to be reattached and to seal the nipple 400 such that the filled cavity 411 with medications, vitamins, or supplements does not drip or release same, except at the pre-structured orifice 410 at the suckling end 404. The detachable portion 408 can be attached and detached with a childproof threaded connection 409. The nipple 400 can be reused by a user as per the preferences of the user and can be used for any medication which is not available or pre-filled commercially. The nipple 400 has a plurality of pre-measured dosage indicators or markings 412a-n printed thereon for enabling a user to precisely measure the medication and supplements.

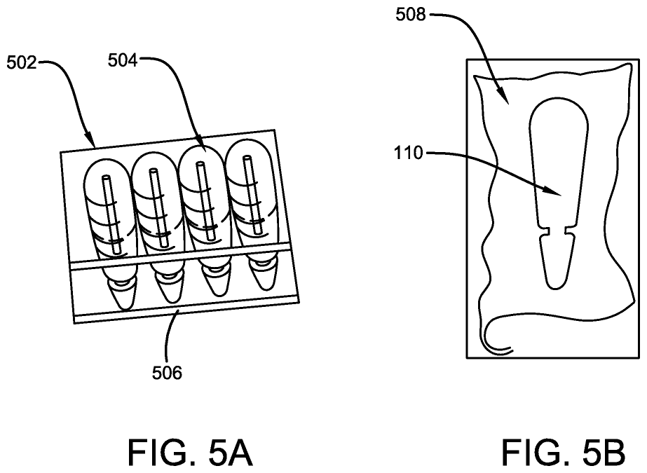

FIG. 5A illustrates one potential packaging arrangement for sanitized nipples used with the medication dispensing pacifier device of the present invention in accordance with the disclosed architecture. In the multi-nipple packaging 502, a plurality of prefilled nipples 504 storing similar or different medications or supplements is contained therein. The packaging 502 may be made of food grade plastic and individual nipples can have an individual slot inside the packaging. The packaging 502 can have a zipper or zip-lock 506, or any other releasable fastener such as hook and loop fastener for securing and accessing the nipples 504.

FIG. 5B illustrates another potential packaging arrangement for sanitized nipples used with the medication dispensing pacifier device of the present invention in accordance with the disclosed architecture. In the present embodiment, the cover 508 is in the form of a pouch for storing a single nipple shown as exemplary nipple 110. The cover 508 can be torn to release and use the nipple 110.

In exemplary embodiments of the present invention, a blue color nipple may indicate that the nipple is prefilled with a cold medicine for infants. An orange color nipple can indicate that Orajel or Numzit is prefilled in the nipple, a red color nipple can indicate baby aspirin, and a yellow color nipple can indicate a prefill of baby vitamins. It should be noted that any color can be used for coding the nipple and can correspond to a specific medication or supplement.

In one embodiment of the present invention, the base of the nipple can have a dimension from about 0.5″ to about 1″. The size of the nipple extending from the suckling end to the notch can have a length from about 1 ⅛″ to about 1 ⅞″.

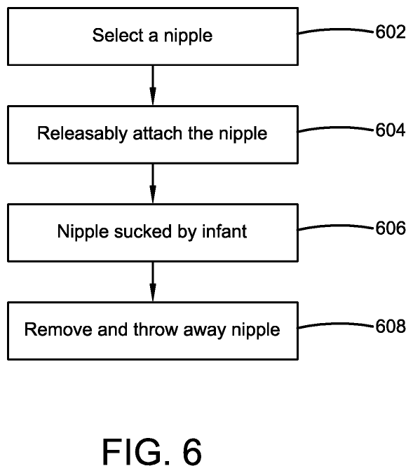

FIG. 6 illustrates a flow diagram depicting steps in use of the prefilled medicated pacifier of the present invention in accordance with the disclosed architecture. Initially, a nipple prefilled with a desired medication or supplement is chosen by a user (Step 602). The nipple is coated in a specific color to indicate a medication stored in the nipple. Then, the nipple is releasably attached to the shield of the pacifier device such that the nipple is interlocked with the shield (Step 604). Thereafter, the nipple is sucked by an infant for receiving medication through an orifice at the suckling end of the nipple (Step 606). Finally, once the medication is fed to the infant, the nipple is removed and thrown away by the user and is replaced with a new nipple for administering another medication (Step 608).

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “dispensing pacifier device”, “pacifier device”, “device”, “prefilled medication pacifier”, “supplement dispensing pacifier device”, and “prefilled vitamin pacifier device” are interchangeable and refer to the prefilled medication pacifier device 100, 300 of the present invention.

Notwithstanding the foregoing, the prefilled medication pacifier device 100, 300 of the present invention can be of any suitable size and configuration as is known in the art without affecting the overall concept of the invention, provided that it accomplishes the above-stated objectives. One of ordinary skill in the art will appreciate that prefilled medication pacifier device 100, 300 as shown in the FIGS. are for illustrative purposes only, and that many other sizes and shapes of the prefilled medication pacifier device 100, 300 are well within the scope of the present disclosure. Although the dimensions of the prefilled medication pacifier device 100, 300 are important design parameters for user convenience, the prefilled medication pacifier device 100, 300 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A dispensing pacifier device comprising:
a pacifier device having a shield, a ring and a nipple;
wherein said shield having a substantially planar body including an interior surface oriented towards the mouth of an infant when said pacifier device is in use and held in the mouth of the infant;
wherein said nipple having a base end and an opposing suckling end including a notch proximal to said base end;
wherein said suckling end having an orifice;
wherein said base end configured to releasably insert said notch through an opening of said shield;
wherein said notch abuts against said shield such that said base end and said suckling end are oriented on opposite sides of said shield when said nipple is mounted to said shield; and
further wherein said nipple having an interior cavity to store and dispense through said orifice pre-measured doses of medication, vitamins, or supplements contained in said nipple when said nipple is held in the mouth of the infant.

2. The dispensing pacifier device of claim 1, wherein said nipple including a material of food grade silicone.

3. The dispensing pacifier device of claim 1, wherein said nipple including a material of food grade rubber.

4. The dispensing pacifier device of claim 1, wherein said nipple is transparent.

5. The dispensing pacifier device of claim 1, wherein said interior cavity of said nipple is prefilled with said pre-measured doses.

6. The dispensing pacifier device of claim 1, wherein said nipple includes a color to correspond to a particular said pre-measured dose.

7. The dispensing pacifier device of claim 1, wherein said ring attached to an exterior surface of said shield and further wherein said ring used for holding said pacifier device.

8. The dispensing pacifier device of claim 1, wherein said nipple is disposable.

9. The dispensing pacifier device of claim 1, wherein said nipple is reusable.

10. The dispensing pacifier device of claim 1, wherein said nipple having a plurality of pre-measured dosage markings printed thereon.

11. A dispensing pacifier device comprising:
a pacifier device having a shield, a ring and a nipple;
wherein said shield having a substantially planar body including an interior surface oriented towards the mouth of an infant when said pacifier device is in use and held in the mouth of the infant;
wherein said nipple having a base end and an opposing suckling end including a notch proximal to said base end;
wherein said suckling end having an orifice;
wherein said base end configured to releasably insert said notch through an opening of said shield;
wherein said notch abuts against said shield such that said base end and said suckling end are oriented on opposite sides of said shield when said nipple is mounted to said shield;
wherein said nipple having a detachable portion selectively removable for filling an interior cavity with measured doses of medication, vitamins, or supplements; and
further wherein said nipple having an orifice at a terminal end of said suckling end for dispensing said measured doses when said nipple is held in the mouth of the infant.

12. The dispensing pacifier device of claim 11, wherein said nipple including a material of food grade silicone.

13. The dispensing pacifier device of claim 11, wherein said nipple is transparent.

14. The dispensing pacifier device of claim 11, wherein said ring attached to an exterior surface of said shield and further wherein said ring used for holding said pacifier device.

15. The dispensing pacifier device of claim 11, wherein said nipple is disposable.

16. The dispensing pacifier device of claim 11, wherein said nipple is reusable.

17. The dispensing pacifier device of claim 11, wherein said nipple having a plurality of pre-measured dosage indicators marked thereon.

18. A supplement dispensing pacifier device comprising:
a pacifier device having a shield, a ring and a nipple;
wherein said shield having a substantially planar body including an interior surface oriented towards the mouth of an infant when said pacifier device is in use and held in the mouth of the infant;
wherein said nipple having a base end and an opposing suckling end including a notch proximal to said base end;
wherein said suckling end having an orifice;
wherein said base end configured to releasably insert said notch through an opening of said shield;
wherein said notch abuts against said shield such that said base end and said suckling end are oriented on opposite sides of said shield when said nipple is mounted to said shield;
wherein said nipple having a detachable portion selectively removable for filling an interior cavity with measured doses of medication, vitamins, or supplements;
wherein said nipple having a plurality of measured dosage indicators marked thereon;
wherein said nipple is transparent; and
further wherein said nipple having an orifice at a terminal end of said suckling end for dispensing said measured doses when said nipple is held in the mouth of the infant.

19. The supplement dispensing pacifier device of claim 18, wherein said nipple including a material of food grade silicone.

20. The supplement dispensing pacifier device of claim 19, wherein said nipple is reusable.
